(19) United States
(12) Patent Application Publication
(10) Pub. No.: US 2005/0050292 A1
(43) Pub. Date: Mar. 3, 2005

(54) Method and apparatus for per-process based virtual memory hierarchy and disk storage for distributed systems enabled as middleware for main memory and disk blocks on demand

(76) Inventor: Jae C. Oh, Jamesville, NY (US)

Correspondence Address: HANCOCK & ESTABROOK, LLP, 1500 MONY TOWER I, PO BOX 4976, SYRACUSE, NY, 13221-4976, US

(21) Appl. No.: 10/848,693

(22) Filed: May 19, 2004

Related U.S. Application Data
(60) Provisional application No. 60/473,617, filed on May 23, 2003.

(51) Int. Cl. G06F 12/00

(52) U.S. Cl. 711/170; 711/117

(57) ABSTRACT

A computer uses per process based virtual memory to implement memory partitions on demand (MPD) and file blocks on demand (FBD) in a distributed computing environment in order to utilize unused memory and unused disk storage. MPD can be implemented directly in a paged-memory system or alternatively can be implemented in a paged-memory system by adding an extra layer in the memory hierarchy between the main memory and the hard disk, thus allowing importing multiple partitions from multiple exporters so that the aggregated remote memory can be huge. FBD uses a bi-directional file header on the computers in the distributed environment that links to any of the file blocks.

### CROSS-REFERENCE TO RELATED APPLICATIONS

This application claims priority from U.S. Provisional Application Ser. No. 60/473,617 filed on May 23, 2003 and entitled PER-PROCESS BASED VIRTUAL MEMORY HIERARCHY AND DISK STORAGE FOR DISTRIBUTED SYSTEMS ENABLED AS MIDDLEWARE FOR MAIN MEMORY AND DISK BLOCKS ON DEMAND, incorporated herein by reference.

### FIELD OF THE INVENTION

This invention relates generally to the field of virtual network computing, and more particularly to implementing memory partitions or file blocks on demand in a distributed computing environment.

### BACKGROUND OF THE INVENTION

Grid computing (or the use of a computational grid) is applying the resources of many computers in a network to a single problem at the same time, usually to a scientific or technical problem that requires a great number of computer processing cycles or access to large amounts of data. In Grid computing, CPU cycles of under-utilized computers are contributed in load-balancing of GRID architecture and Internet-based distributed computing. A well-known example of grid computing in the public domain is the ongoing SETI@Home project (Search for Extraterrestrial Intelligence; www.seti.org) project in which thousands of people are sharing the unused processor cycles of their PCs in the vast search for signs of “rational” signals from outer space.

Grid computing requires the use of software that can divide and farm out pieces of a program to as many as several thousand computers. Grid computing can be thought of as distributed and large-scale cluster computing and as a form of network-distributed parallel processing. It can be confined to the network of computer workstations within a corporation or it can be a public collaboration, in which case it is also sometimes known as a form of peer-to-peer computing.

However, there are other capabilities residing on individual computers which need to be available for use in a global computing environment.

### SUMMARY OF THE INVENTION

Briefly stated, a computer uses per process based virtual memory to implement memory partitions on demand (MPD) and file blocks on demand (FBD) in a distributed computing environment in order to utilize unused memory and unused disk storage. MPD can be implemented directly in a paged-memory system or alternatively can be implemented in a paged-memory system by adding an extra layer in the memory hierarchy between the main memory and the hard disk, thus allowing importing multiple partitions from multiple exporters so that the aggregated remote memory can be huge. FBD uses a bi-directional file header on the computers in the distributed environment that links to any of the file blocks.

According to an embodiment of the invention, a method for implementing global memory partitions on demand includes providing in importer daemon on a first machine; providing an exporter daemon on a second machine; making a memory import decision at the first machine; having the importer daemon contact the exporter daemon; having the exporter daemon set aside a block of memory in the second machine for use by the first machine; and either attaching the block of memory directly as an extension of the memory of the first machine, or attaching the block of memory as an additional memory hierarchy layer between the local memory of the first machine and the storage memory of the first machine.

According to an embodiment of the invention, a method for implementing a single address space view for files stored in various distributed systems includes providing first and second machines with first and second storage memories, respectively, wherein the first and second machines are connected via a network; creating a file in the storage memory of the first machine and allocating additional file blocks of the file to the storage memory of the second machine; and establishing a bi-directional file header in the first and second storage memories that links to the file and the additional file blocks.

### BRIEF DESCRIPTION OF THE DRAWINGS

FIG. 1 shows the concept of memory partitions on demand (MDP) in a paged-memory system.

FIG. 2 shows the concept of MPD in a paged-memory system adding an extra layer in the memory hierarchy between the main memory and the hard disk.

FIG. 3 shows the concept of file blocks on demand (FBD).

FIG. 4 shows a mobile worldwide file system (WFS) using MPD's.

### DETAILED DESCRIPTION OF THE PREFERRED EMBODIMENT

According to the present invention, new mechanisms called Memory Partitions on Demand (MPD), Per Process-based Virtual Memory (PPVM), and File Blocks on Demand (FBD) make it possible for heterogeneous devices in distributed computing environments to share main memories and disk storages on demand. Redundant Array of Independent Disks (RAID) over a network is an example application of the invention but not the invention itself.

MPD implements global memory partitions delivered on demand to applications running on computers when they require more memory while executing. MPD can utilize PPVM to take advantage of the locality of reference programs. If, however, the network latency is not a serious problem, PPVM doesn't have to be used for MPD. In the current technology, however, memory speed is significantly faster than the speed of network. PPVM, therefore, is required and careful locality of reference must be supported to successfully take advantage of what MPD can offer. File blocks on demand delivers disk storage in a similar fashion.

These mechanisms can be used in many computing environments, providing different benefits to each. Environments that can benefit from them include: load balancing in GRID computing. digitally networked home device environments, mobile device environments, and the Internet. In small-scale computing such as in home network and mobile computing environments, devices with little or no memory can take advantage of dynamically available additional memory to run unexpected additional programs that must interact with currently running programs. In large-scale computing such as the Internet, these two mechanisms provide consistent, on-demand memory and storage blocks on demand in a computer infrastructure composed of untrusted peer-to-peer servers.

The OceanStore project as described in John Kubiatowicz, David Bindel, Yan Chen, Patrick Eaton, Dennis Geels, Ramakrishna Gummadi, Sean Rhea, Hakim Weatherspoon, Westly Weimer, Christopher Wells, and Ben Zhao, Oceanstore: An architecture for global-scale persistent storage, Proceedings of ACM ASPLOS (ACM, November 2000), incorporated herein by reference, discloses a similar idea in that any computer and device can join an infrastructure, contribute storage, or provide access to computational resources for economic compensation. MPD extends the idea of OceanStore to main memory. When used in a large-scale distributed environment such as OceanStore, MPD is referred herein to as Worldwide Memory Partitions (WMP).

File blocks on demand provides a single partition view of files unlike OceanStore and most distributed file systems. Therefore, conceptually, file blocks can be scattered among any servers. The Distributed Shared Virtual Memory (DSVM) system as disclosed in C. Morin and I. Puaut, A survey of recoverable distributed shared memory systems, IEEE Trans. on Parallel and Distributed Systems, 8(9):959-969, 1997, incorporated herein by reference, provides a single virtual address space view for pages stored in various distributed systems. FBD does the same for files. Although the granularity can be as small as the client's disk block size, attempts are made to store files in larger chunks of contiguous blocks found in remote disks to improve the file access efficiency. The file system that implements the idea of FBD is called Worldwide File System (WFS) herein.

When used in a massively distributed system, WMP and WFS allow any computer in an infrastructure huge amount of disk storage and memory on demand.

For MPD to be practical, the latency over the network must be properly considered. Currently, the top network speed is about eight times as fast as the top disk I/O access speed (See Table 1). However, the top memory speed (i.e., DDR Rambus memory) is about twice the top network speed.

TABLE 1
Comparisons of data rates in various devices

| Device | Data rate |
|---|---|
| IDE Disk | 5 MB/s |
| EIDE Disk | 16.7 MB/s |
| SCSI Ultra 2 | 80 MB/s |
| SCSI Ultra 3 | 160 MB/s |
| PCI Bus | 528 MB/s |
| Fast Ethernet | 12.5 MB/s |
| Gigabit Ethernet | 125 MB/s |
| 10 Gigabit Ethernet | 1250 MB/s |
| Rambus DDR memory | 800 MB/s-2.1 GB MB/s |

Memory Partitions on Demand (MPD) is a remote memory allocation mechanism that allows computers in an infrastructure to contribute their unused memory partitions to other computers. The idea is similar to contributing CPU cycles of under-utilized computers in load-balancing of GRID architecture and Internet-based distributed computing, but in this case the shared resource is the main memory.

When a computer in the infrastructure needs more memory, it can request memory partitions over the network and “attach” the remote memory partitions to the local memory. Once attached, the newly added partitions can function in two ways, depending on the situation:

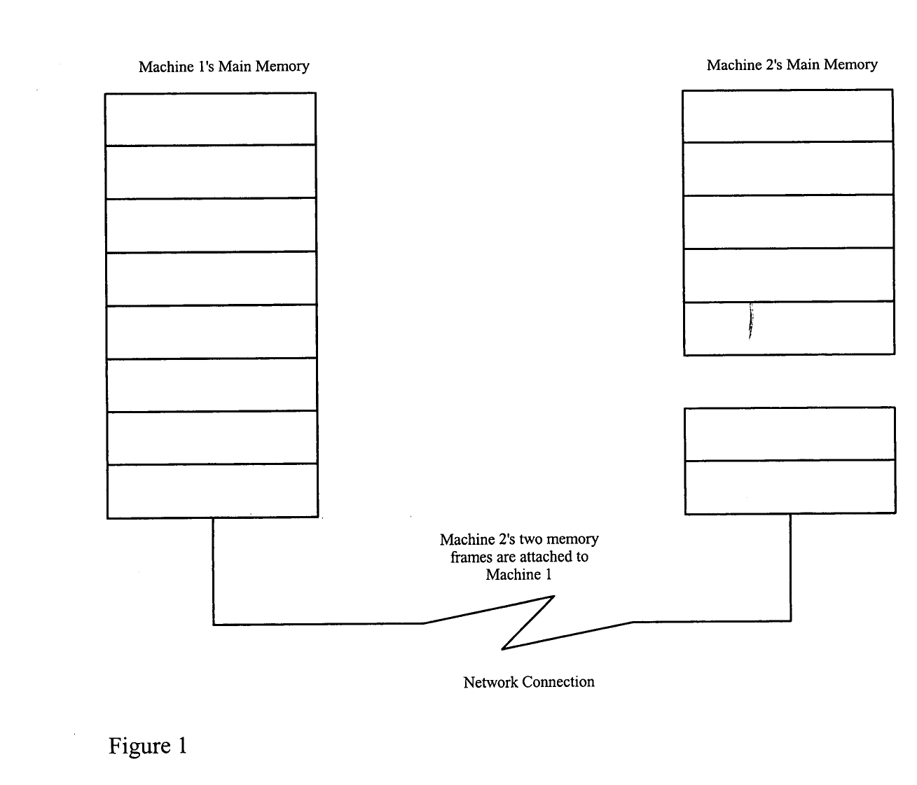

Case 1. Attaching imported memory directly as an extension of local memory. The attached remote memory partitions function as if more physical memory has been added to the local system (FIG. 1). The additional memory partitions are returned to the original owner when no longer necessary. Page tables, other necessary addressing schemes, and related data structures are properly updated so that a software daemon process “fools” the CPU as if more memory has been added. It is, of course, significantly slower to access the remote memory as compared to the local memory. This delay is justified, as is addressed later below.

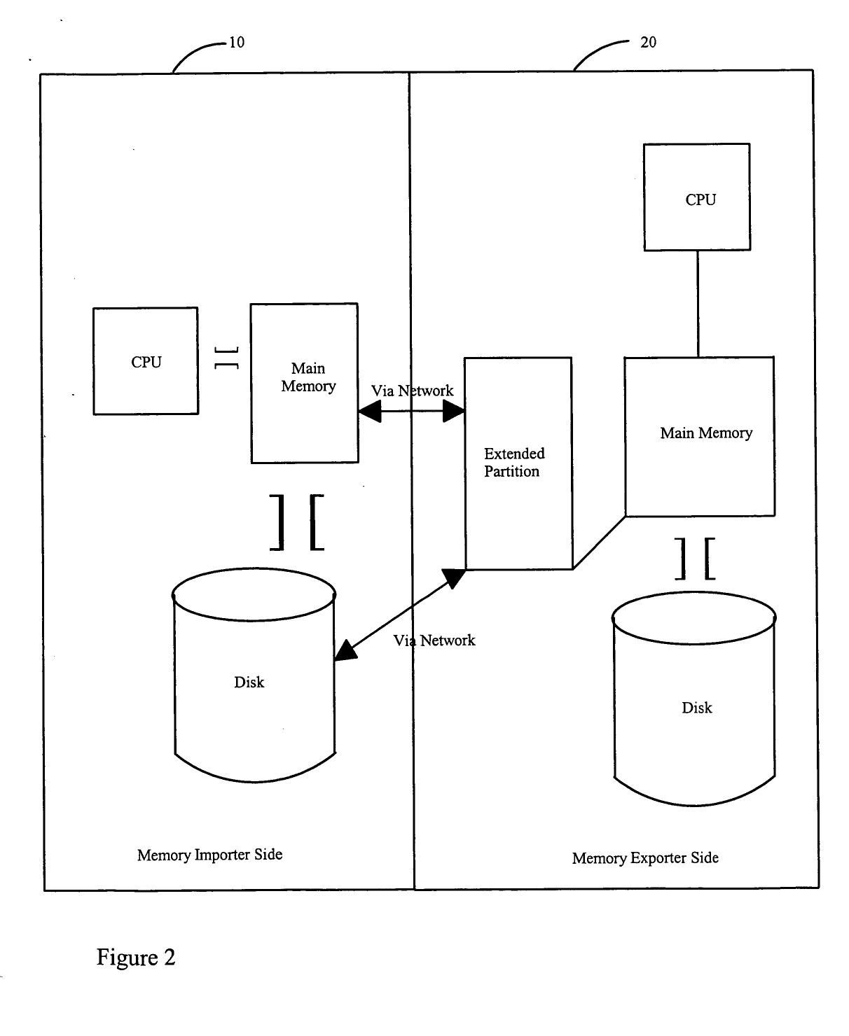

Case 2. Attaching imported memory as an additional memory hierarchy layer between the local memory and the local hard disk using PPVM. The attached remote memory partitions function as an additional layer in the memory hierarchy between the local memory and the hard disk (FIG. 2). This additional layer is a per process entity, i.e., it only exists for the process importing remote memory. If the process uses up the imported memory, it can find more memory partitions over the network and aggregate the new partition with the existing memory partitions. The additional remote memory reduces disk access frequency.

All MPD operations are completely transparent to applications software. FIG. 1 shows the MPD concept for Case 1 above in a paged memory system; MPD, however, doesn't require such a paged memory system to work. MPD is a concept implementation instead of a specific implementation. MPD requires importer side and exporter side daemons. If a memory import decision is made, the importer daemon contacts a match maker and finds memory exporters. An example of contacting a match maker is disclosed in D. H. J. Epema, M. Livny, R. van Dantzig, X. Evers, and J. Pruyne, A worldwide flock of condors: load sharing among workstation clusters, Technical Report DUT-TWI-95-130, Delft, The Netherlands, 1995, incorporated herein by reference. In dynamic load-balancing, MPD can help avoid expensive thread migration, or swapping, or thrashing. A prototype of MPD can be implemented in kernel-level daemons in a Linux/Mosix environment. Mosix is described in Amnon Barak and Oren La'adan, The MOSIX multicomputer operating system for high performance cluster computing, Future Generation Computer Systems, 13(4-5):361-372, 1998. The benefits of using MPD are discussed later below.

FIG. 2 shows the MPD concept for Case 2 above, i.e., the concept of MPD in a paged-memory system by adding an extra layer in the memory hierarchy between the main memory and the hard disk. A machine 10 borrows two memory partitions from a machine 20 over the network. Although only one memory exporter is shown in the figure, the mechanism allows importing multiple partitions from multiple exporters so that the aggregated remote memory can be huge. The exporter's exported memory partition becomes a new layer in the importer's memory hierarchy.

FBD (File Blocks on Demand) supports a single partition view of files even if blocks of files are stored in different disks over the network. Among existing systems, the MOPI file system (described in Lior Amar Amnon, The mosix scalable cluster file systems for linux) for MOSIX is probably the most closely related to FBD. MOPI splits a big data file into several chunks and stores a chunk on each node that will run the respective processes to the data chunks so that each process will only have to perform local disk I/Os. There are a few cluster file systems including Global File System (GFS) as developed by Sistina Software, Inc., Parallel Virtual File System (PVFS) as described in P. H. Cams, W. B. Ligon, R. B. Ross, and R. Thakur, PVFS: A parallel file system for linux clusters, Proceedings of 4th Annual Linux Conference, pages 317-327, 2000, and “Panda” as described in Yong Cho, Marianne Winslett, Mahesh Subramaniam, Ying Chen, Szu wen Kuo, and Kent E. Seamons, Exploiting local data in parallel array I/O on a practical network of workstations, Proceedings of the Fifth Workshop on Input/Output in Parallel and Distributed Systems, pages 1-13, San Jose, Calif., 1997. ACM Press, al;l of which try to improve disk I/O access time by creating multiple processes to access different segments of a file at the same time.

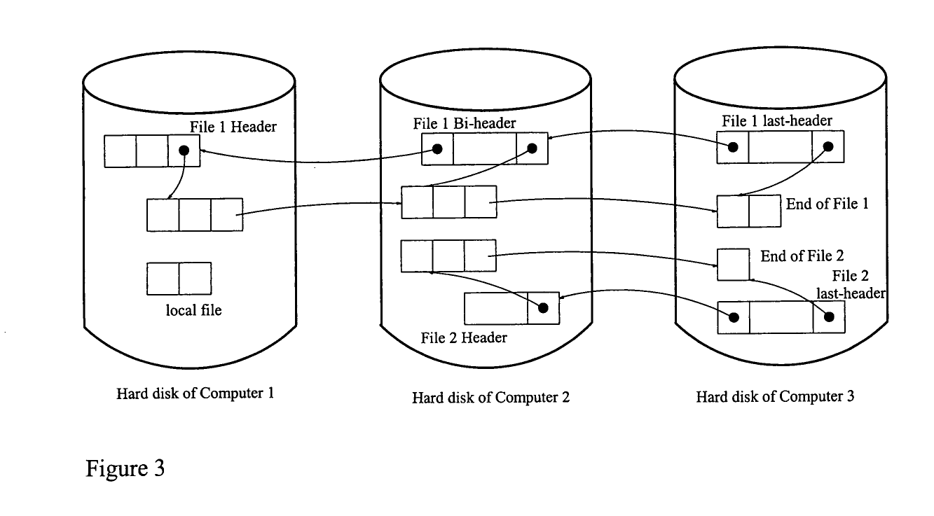

The FBD's primary goal is to provide a huge file system by daisy-chaining hard disks via network. It also allows the MOPI-style parallel file access. FIG. 3 shows the concept of the FBD system. Each hard disk belongs to a local machine, with the machines (computers) connected via a network. A file can be initially created in any computer and additional file blocks can be allocated to any other computer's hard disk. Each computer has a bi-directional file header that links to any of the file blocks. Worldwide File System (WFS), the file system using FBD, coexists with local file systems. By daisy-chaining hard disks over the network, any arbitrarily large files can be created. In each hard disk, there is a file header for a file, a normal header at the first hard disk in the daisy-chain and a bi-directional header in the hard disks in the middle and the end. Therefore, it is possible to access a file from any computer in the chain without going through the first file header in a remote disk.

WFS can work regardless however disk blocks are scattered over remote disks but it is preferred to preserve the locality of reference in physical locations of disk blocks. WFS makes its best effort to allocate contiguous file blocks by daisy-chaining contiguously allocatable remote disk blocks when the local hard disk is badly fragmented. In WFS, file blocks can be more contiguously allocated when daisy-changed over the network, improving disk access time by avoiding accessing a badly fragmented local disk. The disk seek delay can be reduced to a single seek delay if all the hard disks in the chain access the respective local blocks at the same time. The FBD mechanism can support a networked RAID system treating hard disks in the daisy-chain as RAID.

The success of MPD and FBD is critically dependent on the network speed, because in some environments such as the GRID, migrating processes to a different node when the memory is not sufficient may be an alternative to MPD. Often, however, current network technology will justify the use of MPD/FBD. In July 2002, Lawrence Berkeley Laboratory demonstrated the feasibility of a 10-Gigabit network, which is about eight times the speed of the top-of-the-line data rate of an Ultra 3 SCSI disk. However, when compared to the top memory data rate, the top network data rate is about twice as slow. Therefore, careful design decisions must be made in implementing MPD when the remote memory partitions are directly communicating with the local CPU. (See Case 1 above.) Table 1 shows the data rates of various devices. MPD and FBD are useful under this data rate assumption.

These are a few examples of when MPD can be useful. Using MPD can avoid possibly expensive process migrations. In dynamic load-balancing systems like MOSIX, processes are migrated from a node that is running out of main memory to avoid swapping and thrashing, i.e., memory ushering. A process is migrated under the assumption that at least 50% of computation remains. After a process has migrated to a new node, if input/output intensive operations that can only be accomplished using the data stored in the original node are necessary, network file input/output is expensive (i.e., network delay+disk access time in the original node). MOSIX tries to address this problem with the MOSIX Scalable Parallel Input/Output (MOPI) system. MOPI splits files and distributes the parts to several nodes. Then it tries to migrate parallel processes to the respective nodes that hold the data necessary for each process.

In the present invention, however, by making more memory available on demand, MPD can allow the process to finish its computation without migrating to a different node. Notice that MPD does not replace the process migration mechanism, but rather provides another option. MPD is particularly useful when a process is close to the end of the execution because it is more efficient to finish the process in the local node rather than migrating the process to a different node. It is hard to estimate how much computation remains given a process. Nevertheless, sometimes this information may be available or at least it can be estimated. MPD can be particularly useful when the remote memory is used for dynamic data allocations that won't need to be written to the disk. A careful decision has to be made whether to migrate the process or use MPD.

MPD will make it possible to run unexpected additional processes that interact with currently running processes even if local memory is scarce. For example, imagine a set of interacting processes running on a specialized personal digital assistant installed in an automobile: a GPS communication process that receives satellite data, a route-finding process that uses the GPS data, a process that communicates with a refrigerator at home to see what grocery items need to be purchased. and a process that finds the nearest grocery store on the way home. All these processes must run at the same time because they all are dependent on each other. If there is an incoming Internet phone call when not enough memory is available, either the phone call has to be cancelled or one or more running processes must be suspended or killed. MPD can resolve the problem by fetching additional memory on the fly over the network from a willing memory server.

An alternative way to resolve this problem is to adopt a thin-client technology such as Citrix as described in T. W. Mathers and S. P. Genoway, Windows NT Thin Client Solutions: Implementing Terminal Server and Citrix MetaFrame, Macmillan Technical Publishing, Indianapolis, Ind., 1998., VNC (Virtual Network Computing) as described at http://www.uk.research.att.corn/vnc/, or Platform Independent Network Virtual Memory (PINVM) Hierarchy (U.S. Provisional Patent Application Ser. No. 60/473,633 filed May 23, 2002), each of which is incorporated herein by reference, to these small devices. However, unlike with pure thin-client technology, devices using MDF do not need constant network connections except during the MPD session. For mobile devices, network connections may not always be reliable.

Worldwide Memory Partitions. Many computers on the Internet have much more main memory and hard disks spaces than needed (e.g., home computers, administrative office computers, etc.). Especially at night, most computing resources are wasted, including the main memory. There are many attempts to share CPU cycles and disk storage, such as, for example, Mojo Nation (www.mojonation.net) and Seti@home, but to our knowledge, there has been no attempt to share the main memory of under-utilized computers over the Internet. Computers in the Internet can import or export main memory much the same way as CPU clock cycles and disk storages are shared.

WFS decreases disk access time when the network speed is faster than the local hard disk access time. When a large file is being written and more disk space is needed, WFS can be used to daisy-chain hard disks. For a severely fragmented local hard disk, it can be beneficial to write file blocks to a remote hard disk that can provide a large set of contiguous file blocks to decrease disk seek time. WFS can also behave like a network virtual RAID. All the hard disks in the daisy-chain can read the corresponding blocks at the same time and send the data over the network to the requester. This is useful particularly in the GRID environment.

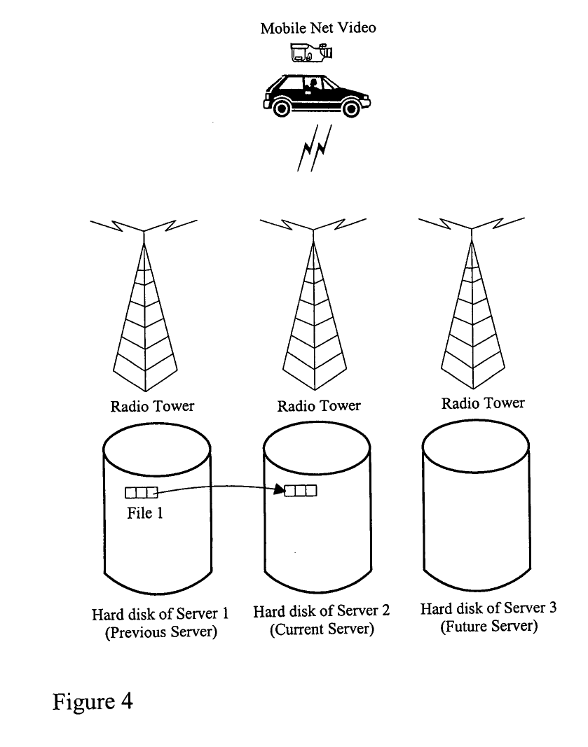

WFS can provide an arbitrarily large disk space for a traveling mobile device. Referring to FIG. 4, imagine a mobile camera equipped with network capability, of which new mobile phone models are examples. A person in a car on a highway can take continuous video images, for example, during an entire ten hour trip by storing the video data to the storage of servers along the way from the start to the destination. The video data can be sent to the person's personal computer on-the-fly, or alternatively, after the trip is over, the data stored in all the servers can be automatically downloaded to the person's local hard disk at home. Another way is to transfer partial files stored in the previous server when the automobile moves to a new server. FIG. 4 shows this example concept. Note that servers can be commercial servers or personal computers that are willing to export their disk space.

WFS can support input/output intensive process migration in dynamic load-balancing. When an input/output intensive process migrates from its home node to another node, the input/output overhead after the migration is significant. MOSIX addresses this problem via the MOPI system in which files are split and distributed among several nodes. However, MOPI uses a static algorithm, so the file must be split before parallel processing and an assumption is made that multiple processes are accessing different parts of the file. In contrast, WFS reduces read and write operations of a migrating process in the following way. In write operations, WFS simply lets the process write to the local hard disk of the current computing node, much the same as in most cluster file systems. But since the file blocks are daisy-chained over the network, the entire file can be accessed from any node. In read operations, WFS uses a migration predictive algorithm to infer the next node that the process may migrate to and then transfers the part of the data file that will be needed to the next node while the process is still running on the current node.

Along with WMP, WFS can be used in a massively distributed system environment such as the Internet. In such an environment, interesting game theoretic behaviors occur among selfishly rational agents (e.g. computers). There has been proposed an Internet-based computer resource sharing of disk space and CPU cycles (www.mojonation.com) but not of main memory. With two of the proposed mechanisms of the present invention, we can construct self-evolving infrastructure of computers owned by different individuals and institutions participating in cooperative sharing of computational resources.

WMP pages and WFS disk blocks can be replicated throughout the infrastructure. A computer may decide to replicate memory contents (i.e., pages in a paged-memory system) and disk blocks for two reasons:
(1) It may require the memory contents and disk blocks for its own current and future usages provided that it is authorized to use them.
(2) It may want to keep the memory contents and disk blocks for others to use for economic compensation in the future. The economic compensation can either be money or computational resources.

Since the memory contents and disk blocks are replicated promiscuously, the proposed system requires cryptographic techniques to protect data from unauthorized servers that store these data. Cryptographic techniques are well known in the art and it is believed that cryptographic techniques can be applied to the present inventions with no more than routine experimentation by one of ordinary skill in the art.

Computers must decide whether to contribute memory partitions and disk storage blocks based on the expected utility value gained by lending the resources to others in the infrastructure. Game theoretical decisions can be made by communicating with a relatively small number of other computers or devices in the infrastructure, since communicating with every node would be prohibitively expensive, as well as impractical given the constantly shifting composition of the network as various devices either connect or disconnect. Dennis Geels and John Kubiatowicz, Replica management should be a game, SIGOPS European Workshop, 2002, incorporated herein by reference, suggests that replica management in a large scale distributed computing environment should be a game. When selfishly rational computers in massively distributed environments share resources, an interesting game theoretical dilemma occurs which can be resolved by treating it as a game theoretical problem and finding a proper policy that leads to an optimal cooperative sharing behavior of the computers.

While the present invention has been described with reference to a particular preferred embodiment and the accompanying drawings, it will be understood by those skilled in the art that the invention is not limited to the preferred embodiment and that various modifications and the like could be made thereto without departing from the scope of the invention as defined in the following claims.

1. A method of implementing global memory partitions on demand, comprising the steps of:
providing in importer daemon on a first machine, said first machine including a memory;
providing an exporter daemon on a second machine;
making a memory import decision at said first machine;
having said importer daemon contact said exporter daemon;
having said exporter daemon set aside a block of memory in said second machine for use by said first machine; and
either attaching said block of memory directly as an extension of said memory of the first machine, or attaching said block of memory as an additional memory hierarchy layer between a local memory of said first machine and a storage memory of said first machine.

2. A method for implementing a single address space view for files stored in various distributed systems, comprising the steps of:
providing first and second machines with first and second storage memories, respectively, wherein said first and second machines are connected via a network;
creating a file in said storage memory of said first machine and allocating additional file blocks of said file to said storage memory of said second machine; and
establishing a bidirectional file header in said first and second storage memories that links to said file and said additional file blocks.
